(19) United States
(12) Patent Application Publication
(10) Pub. No.: US 2026/0005786 A1
(43) Pub. Date: Jan. 1, 2026

(54) METHOD, SYSTEM AND STORAGE MEDIUM OF SIGNAL ACQUISITION BASED ON SELECTIVE COHERENT INTEGRATION FOR ANTI-JAM OF PROTECTED GLOBAL POSITIONING SYSTEM USER EQUIPMENT

(71) Applicant: Intelligent Fusion Technology, Inc., Germantown, MD (US)

(72) Inventors: Dan SHEN, Germantown, MD (US); Genshe CHEN, Germantown, MD (US); Khanh PHAM, Kirtland AFB, NM (US)

(21) Appl. No.: 18/759,628

(22) Filed: Jun. 28, 2024

(51) Int. Cl. H04K 3/00; G01S 19/21

(52) U.S. Cl. CPC H04K 3/25; G01S 19/21

(57) ABSTRACT

A signal acquisition method includes: establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal; and executing FFT based convolution on the prime code signal, the first local replica and the second local replica to yield two convolution results; comparing two convolution maximum peak values and selecting convolution maximum peak values with higher magnitude in the sub-integration pair as first and second convolution peak values; and comparing the first convolution peak value and the second convolution peak value to obtain a corresponding IFFT convolution result to be outputted.

### GOVERNMENT RIGHTS

The present disclosure was made with Government support under Contract No. FA945322PA005, awarded by the United States Air Force Research Laboratory. The U.S. Government has certain rights in the present disclosure.

### FIELD OF THE DISCLOSURE

The present disclosure generally relates to the field of satellite communication technology and, more particularly, relates to a method, a system and a storage medium of signal acquisition based on based on selective coherent integration (SCI) for anti-jam of protected global positioning system (GPS) user equipment.

### BACKGROUND

Anti-jam (AJ) research and product development for global positioning system (GPS) user equipment (UE) have historically focused on high-performance systems like adaptive antenna arrays for nearly three decades. While these systems have indeed improved AJ performance, the systems may not be operationally suitable for various applications and equipment with stringent size, weight, power and cost (SWaP-C) constraints. For instance, handheld receivers, small-unmanned aerial/ground vehicles and diver underwater navigation systems may struggle to adopt adaptive antenna systems due to array sizes, high costs, and computational complexity.

There is an urgent need to develop and assess signal processing approaches and algorithms aimed at enhancing AJ capabilities for GPS user equipment with significant SWaP-C limitations. The target is to achieve improvement of at least 20 dB (with an objective of 30 dB) over current AJ performance specified for the Increment 1 ground-based receiver, particularly in the presence of both narrowband and broadband jammers (e.g., CW (continuous waveform), pulsed CW, swept CW, matched spectral and/or Gaussian noise).

### BRIEF SUMMARY OF THE DISCLOSURE

One aspect of the present disclosure provides a signal acquisition method based on selective coherent integration (SCI) for anti-jam of protected global positioning system (GPS) user equipment. The method includes establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal, where the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results; comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

Another aspect of the present disclosure provides a system. The system includes a memory, configured to store program instructions for performing a signal acquisition method based on selective coherent integration (SCI) for anti-jam of protected global positioning system (GPS) user equipment; and a processor, coupled with the memory and, when executing the program instructions, configured for: establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal, where the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results; comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

Another aspect of the present disclosure provides a non-transitory computer-readable storage medium, containing program instructions for, when being executed by a processor, performing signal acquisition method based on selective coherent integration (SCI) for anti-jam of protected global positioning system (GPS) user equipment. The method includes establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal, where the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results; comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary method of signal acquisition based on selective coherent integration for anti-jam of protected global positioning system (GPS) user equipment according to various disclosed embodiments of the present disclosure.

FIG. 2 depicts an exemplary block diagram of a TRANSEC (transmission security) in a reference code system according to various disclosed embodiments of the present disclosure.

FIG. 3 depicts an exemplary block diagram of a TRANSEC (transmission security) in a prime code system according to various disclosed embodiments of the present disclosure.

FIG. 4A depicts an exemplary schematic of estimated PSD (power spectral density) of a sine-phased prime code signal according to various disclosed embodiments of the present disclosure.

FIG. 4B depicts an exemplary schematic of estimated PSD (power spectral density) of a cosine-phased prime code signal according to various disclosed embodiments of the present disclosure.

FIG. 5A depicts an exemplary schematic of magnitude autocorrection function of a prime code signal according to various disclosed embodiments of the present disclosure.

FIG. 5B depicts an exemplary schematic of magnitude autocorrection function of a reference code signal according to various disclosed embodiments of the present disclosure.

FIG. 6A depicts an exemplary schematic of PSD (power spectral density) of baseband L1 signals in I branch according to various disclosed embodiments of the present disclosure.

FIG. 6B depicts an exemplary schematic of PSD (power spectral density) of baseband L1 signals in Q branch according to various disclosed embodiments of the present disclosure.

FIG. 7A depicts an exemplary schematic of a three-dimensional cross ambiguity function (CAF) according to various disclosed embodiments of the present disclosure.

FIG. 7B depicts an exemplary schematic of a contour of a cross ambiguity function (CAF) according to various disclosed embodiments of the present disclosure.

FIG. 8 depicts an exemplary schematic of two-dimensional grid search in time-frequency domain according to various disclosed embodiments of the present disclosure.

FIG. 9 depicts an exemplary schematic of selective coherent integration (SCI) according to various disclosed embodiments of the present disclosure.

FIG. 10 depicts an exemplary block diagram of selective coherent integration (SCI) based parallel and direct acquisition for prime code signals according to various disclosed embodiments of the present disclosure.

FIG. 11A depicts an exemplary schematic of average correlation from selective coherent integration (SCI) for prime code signal acquisition for M=1 according to various disclosed embodiments of the present disclosure.

FIG. 11B depicts an exemplary schematic of average correlation from selective coherent integration (SCI) for prime code signal acquisition for M=2 according to various disclosed embodiments of the present disclosure.

FIG. 11C depicts an exemplary schematic of average correlation from selective coherent integration (SCI) for prime code signal acquisition for M=3 according to various disclosed embodiments of the present disclosure.

FIG. 11D depicts an exemplary schematic of average correlation from selective coherent integration (SCI) for prime code signal acquisition for M=4 according to various disclosed embodiments of the present disclosure.

FIG. 12A depicts an exemplary schematic of detection probabilities for M=20 according to various disclosed embodiments of the present disclosure.

FIG. 12B depicts an exemplary schematic of detection probabilities for M=40 according to various disclosed embodiments of the present disclosure.

FIG. 13A depicts an exemplary schematic of acquisition margins for M=20 according to various disclosed embodiments of the present disclosure.

FIG. 13B depicts an exemplary schematic of acquisition margins for M=40 according to various disclosed embodiments of the present disclosure.

FIG. 13C depicts an exemplary schematic of acquisition margins for M=20 according to various disclosed embodiments of the present disclosure.

FIG. 13D depicts an exemplary schematic of acquisition margins for M=40 according to various disclosed embodiments of the present disclosure.

FIG. 14 depicts an exemplary schematic of two scenarios for setting jamming powers according to various disclosed embodiments of the present disclosure.

FIG. 15A depicts an exemplary schematic of detection probabilities for M=20 at scenario 1 according to various disclosed embodiments of the present disclosure.

FIG. 15B depicts an exemplary schematic of detection probabilities for M=40 at scenario 1 according to various disclosed embodiments of the present disclosure.

FIG. 16A depicts an exemplary schematic of acquisition margins for M=20 at scenario 1 according to various disclosed embodiments of the present disclosure.

FIG. 16B depicts an exemplary schematic of acquisition margins for M=40 at scenario 1 according to various disclosed embodiments of the present disclosure.

FIG. 16C depicts an exemplary schematic of acquisition margins for M=20 at scenario 1 according to various disclosed embodiments of the present disclosure.

FIG. 16D depicts an exemplary schematic of acquisition margins for M=40 at scenario 1 according to various disclosed embodiments of the present disclosure.

FIG. 17A depicts an exemplary schematic of average correlation from selective coherent integration (SCI) for prime code signal acquisition for M=1 according to various disclosed embodiments of the present disclosure.

FIG. 17B depicts an exemplary schematic of average correlation from selective coherent integration (SCI) for prime code signal acquisition for M=2 according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

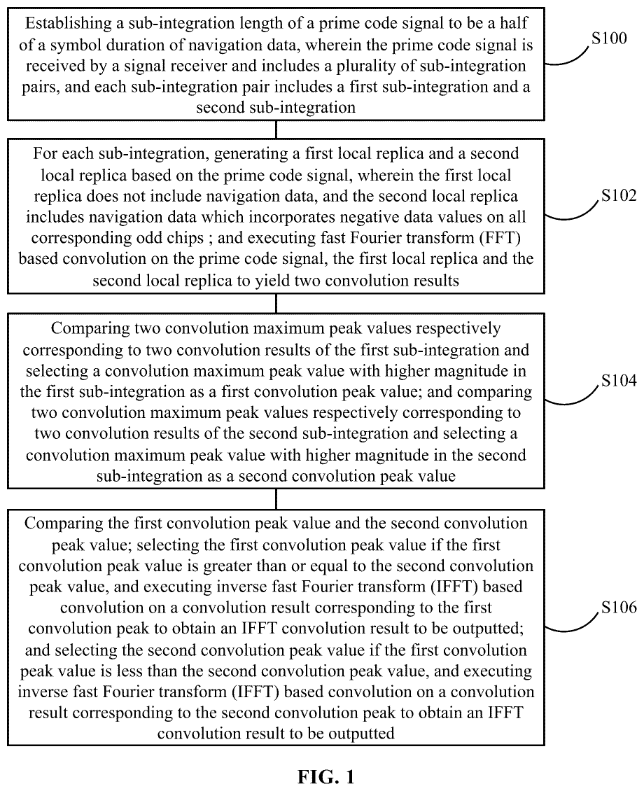

According to various embodiments of the present disclosure, a method of signal acquisition based on selective coherent integration (SCI) for anti-jam of protected global positioning system (GPS) user equipment is described hereinafter. FIG. 1 depicts an exemplary method of signal acquisition based on selective coherent integration for anti-jam of protected GPS user equipment according to various disclosed embodiments of the present disclosure.

At S100, a sub-integration length of a prime code signal is established to be a half of a symbol duration of navigation data, where the prime code signal is received by a signal receiver and includes a plurality of sub-integration pairs, and each sub-integration pair includes a first sub-integration and a second sub-integration.

At S102, for each sub-integration, a first local replica and a second local replica based on the prime code signal are generated, where the first local replica does not include navigation data, and the second local replica includes navigation data which incorporates negative data values on all corresponding odd chips; and fast Fourier transform (FFT) based convolution is executed on the prime code signal, the first local replica and the second local replica to yield two convolution results.

At S104, two convolution maximum peak values respectively corresponding to two convolution results of the first sub-integration are compared, and a convolution maximum peak value with higher magnitude in the first sub-integration is selected as a first convolution peak value; and two convolution maximum peak values respectively corresponding to two convolution results of the second sub-integration are compared, and a convolution maximum peak value with higher magnitude in the second sub-integration is selected as a second convolution peak value.

At S106, the first convolution peak value and the second convolution peak value are compared; the first convolution peak value is selected if the first convolution peak value is greater than or equal to the second convolution peak value, and inverse fast Fourier transform (IFFT) based convolution is executed on a convolution result corresponding to the first convolution peak to obtain an IFFT convolution result to be outputted; and the second convolution peak value is selected if the first convolution peak value is less than the second convolution peak value, and inverse fast Fourier transform (IFFT) based convolution is executed on a convolution result corresponding to the second convolution peak to obtain an IFFT convolution result to be outputted.

In one embodiment, after selecting the first convolution peak value if the first convolution peak value is greater than the second convolution peak value, the method further includes if a ratio of the second convolution peak value over the first convolution peak value exceeds a predefined threshold, selecting the second convolution peak value.

In one embodiment, the method further includes executing inverse fast Fourier transform (IFFT) based convolution on convolution results corresponding to the first convolution peak and the second convolution peak value to respectively obtain two IFFT convolution results; and summing the two IFFT convolution results to obtain summed IFFT convolution result to be outputted.

In one embodiment, after selecting the second convolution peak value if the first convolution peak value is less than the second convolution peak value, the method further includes if a ratio of the first convolution peak value over the second convolution peak value exceeds a predefined threshold, selecting the first convolution peak value.

In one embodiment, the method further includes executing inverse fast Fourier transform (IFFT) based convolution on convolution results corresponding to the first convolution peak and the second convolution peak value to respectively obtain two IFFT convolution results; and summing the two IFFT convolution results obtain summed IFFT convolution result to be outputted.

In one embodiment, executing fast Fourier transform (FFT) based convolution on the prime code signal, the first local replica and the second local replica to yield two convolution results includes executing fast Fourier transform (FFT) based convolution on the prime code signal and the first local replica to yield one convolution result; and executing fast Fourier transform (FFT) based convolution on the prime code signal and the second local replica to yield another second convolution result.

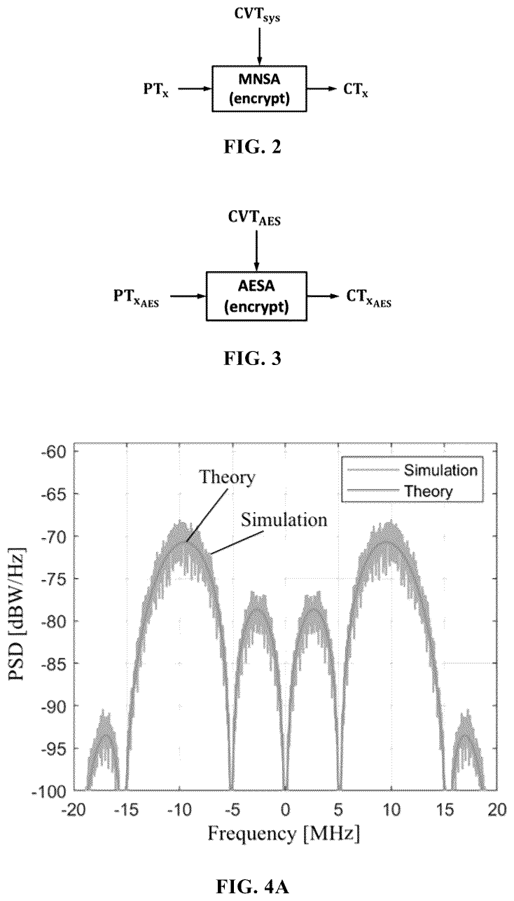

The prime code, a simplified version of a reference code, is employed to showcase direct acquisition algorithm in the present disclosure. The generation of the reference code may include two main processes, that is, PRN (pseudorandom noise) sequence generation and subcarrier modulation. PRN sequence generation may rely on the modernized Navstar security algorithm (MNSA) to produce ciphertext. FIG. 2 depicts an exemplary block diagram of a TRANSEC (transmission security) in a reference code system according to various disclosed embodiments of the present disclosure. Referring to FIG. 2, the reference code signal is managed by a system known as TRANSEC (transmission security) (CVTsys, system TRANSEC crypto-variable). Such system may accept 128-bit blocks of plaintext (PTx) as input and yield 128-bit blocks of ciphertext (CTx) as output, where X denotes various functionalities such as PA (puncture acquisition) or PAT (puncture acquisition timing) or the reference code PRN. FIG. 3 depicts an exemplary block diagram of a TRANSEC (transmission security) in a prime code system according to various disclosed embodiments of the present disclosure. However, referring to FIG. 3, in the case of the prime code system, advanced encryption standard algorithm (AESA) serves as the TRANSEC instead of MNSA. The prime code chips (bits or digits) may be the output bit streams (cipher text) of the AESA algorithm (i.e., codebook). The AES codebooks (aka AESA algorithms available from public domain) may mix (i.e., time multiplexed): 1) ranging code bit sequences (i.e., Plaint Text in nature and unique for a spacecraft) and 2) puncture chip sequences (i.e., controlled by the AESA). Resulting cipher text bit streams may include bits some of which are flipped from Os to 1s or vice versa depending on marker bits with the puncture chip sequences.

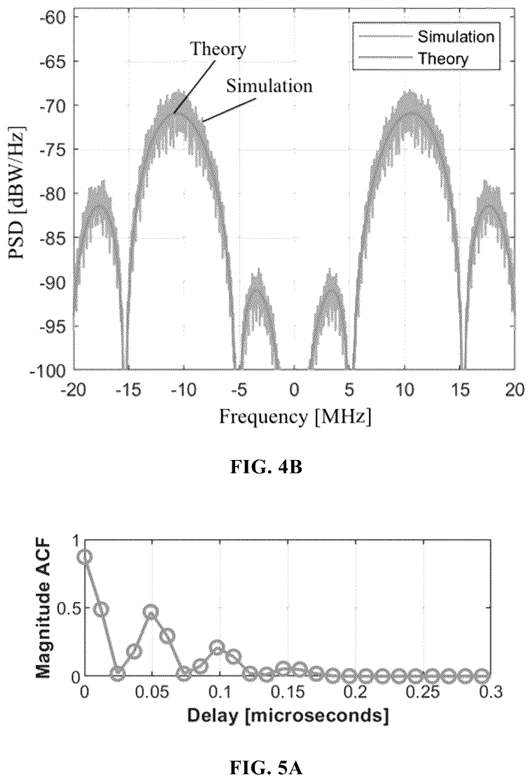

FIG. 4A depicts an exemplary schematic of estimated PSD (power spectral density) of a sine-phased prime code signal according to various disclosed embodiments of the present disclosure; and FIG. 4B depicts an exemplary schematic of estimated PSD of a cosine-phased prime code signal according to various disclosed embodiments of the present disclosure. The prime code signal may be implemented in MALAB, and estimated power spectral density (PSD) may be obtained as shown in FIGS. 4A-4B, where theoretical PSDs may be shown to verify implementation correctness.

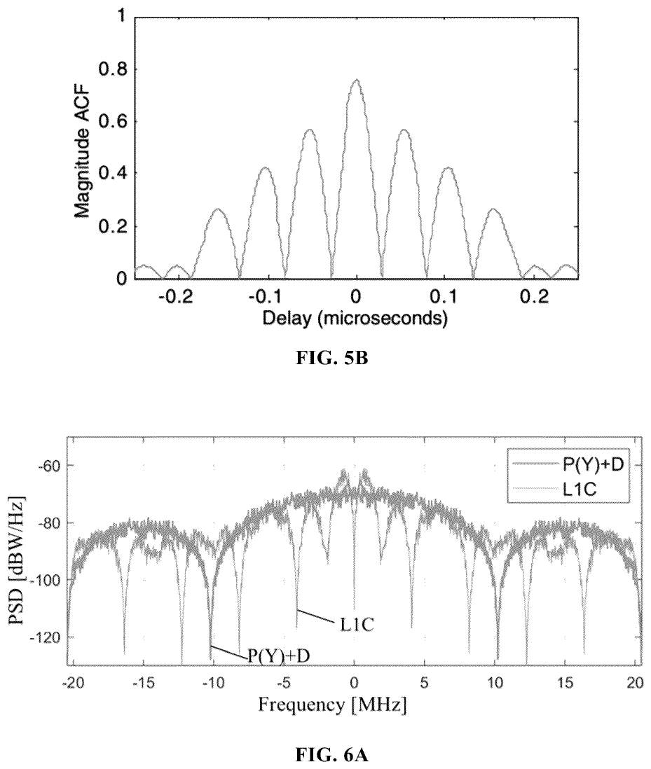

In addition, comparison between normalized autocorrelation result of the prime code signal (FIG. 5A) and normalized autocorrelation result of the reference code signal (FIG. 5B) may be conducted. FIG. 5A depicts an exemplary schematic of magnitude autocorrection function of a prime code signal according to various disclosed embodiments of the present disclosure; and FIG. 5B depicts an exemplary schematic of magnitude autocorrection function of a reference code signal according to various disclosed embodiments of the present disclosure. The comparison shown in FIGS. 5A-5B may be configured to validate implementation correctness.

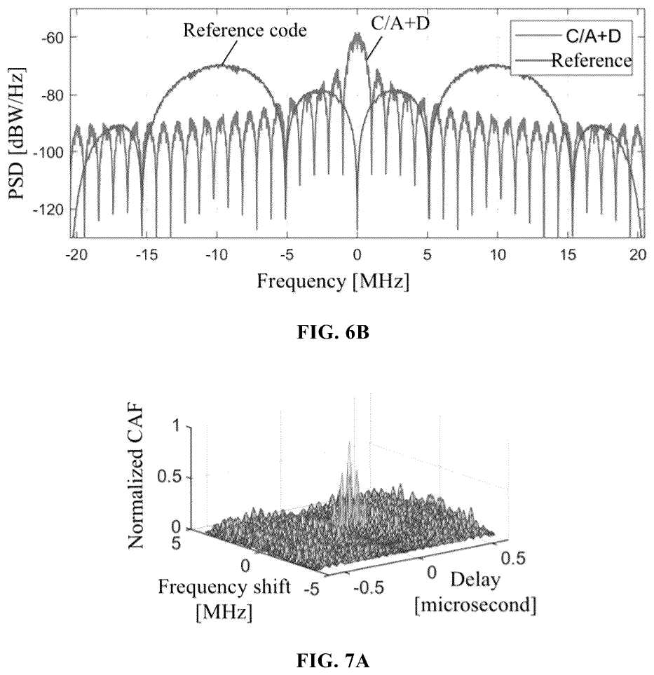

FIG. 6A depicts an exemplary schematic of PSD of baseband L1 signals in I branch according to various disclosed embodiments of the present disclosure; and FIG. 6B depicts an exemplary schematic of PSD of baseband L1 signals in Q branch according to various disclosed embodiments of the present disclosure. I and Q branches may be in-phase and quadrature carrier signals, respectively; and may be two data bitstreams (referred to as in-phase and quadrature data bits naturally because I and Q branches are transmitted on the in-phase and quadrature carriers). Referring to FIGS. 6A-6B, a sampling rate may be about 40.92 MHz, and a resolution bandwidth (RBW) may be about 20 kHz. The present disclosure provides a baseband signal generator capable of producing modern GPS L1 signals, including the C/A code, the P (Y) code, the LIC code, and the prime code. The implementation of the present disclosure may adhere closely to the specifications outlined in the GPS Interface Control Documents (ICDs) and prime code Interface Control Document (ICD). The results obtained from the signal generator are presented in FIGS. 6A-6B.

According to various embodiments of the present disclosure, selective coherent integration (SCI) based direct acquisition is described in detail hereinafter.

The acquisition of the prime code signal may primarily rely on direct acquisition. In the acquisition process, a (signal) receiver may correlate a locally generated replica of the prime code signal with received waveform, which may consider both time and frequency shifts. The cross ambiguity function (CAF) may be configured as a crucial tool for comprehending the signal acquisition process, which may offer insights into the correlation between the transmitted and received signals across various time and frequency offsets.

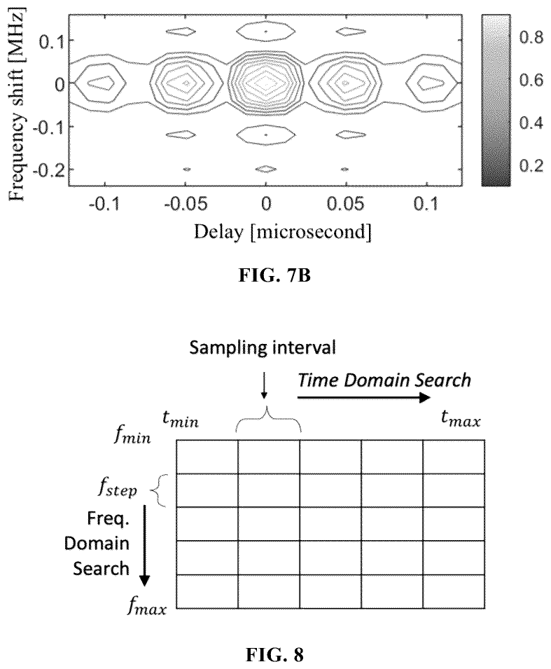

The acquisition may be searching the peak in the CAF. FIG. 7A depicts an exemplary schematic of a three-dimensional CAF according to various disclosed embodiments of the present disclosure; and FIG. 7B depicts an exemplary schematic of a contour of the CAF according to various disclosed embodiments of the present disclosure. FIG. 8 depicts an exemplary schematic of two-dimensional grid search in time-frequency domain according to various disclosed embodiments of the present disclosure. A typical CAF of the prime code signal is illustrated in FIGS. 7A-7B, which may correspond to the grid search as shown in FIG. 8, where

$${f}_{step} = \frac{{f}_{s}}{N} , {f}_{step}$$

denotes a frequency step function, fs denotes a sampling frequency, and N denotes a number of samples. Given low SWAP-C requirements, there is a need for a parallel and efficient approach to conduct the two-dimensional (2D) grid search of the CAF.

When a weak yet long-lived (or repetitive) signal is extracted from noise, integration may become crucial. Integration may involve combining or averaging the signals received at different times. Two distinct methods may be configured for integration, which include coherent integration and non-coherent integration. Coherent integration may indicate that the signals may be averaged first, and corresponding strengths (powers) may be determined. Non-coherent integration may be the opposite, that is, the strengths (powers) may be determined first, and corresponding strengths may be averaged.

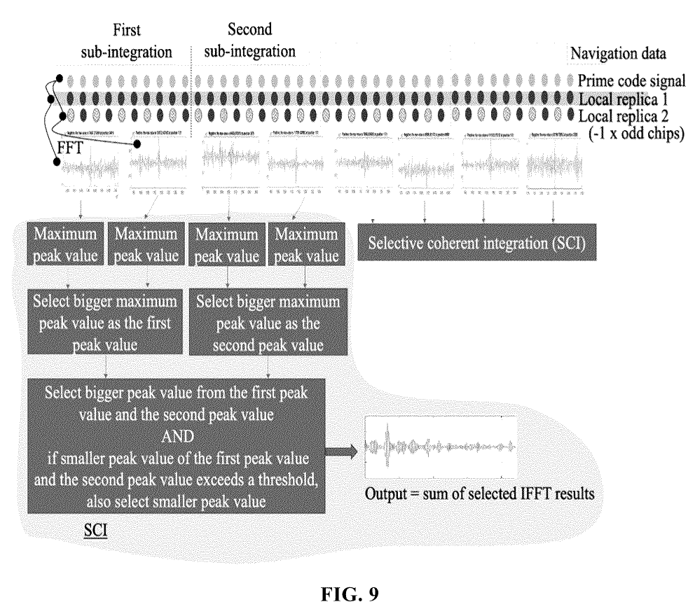

Due to special data bits (modulated to odd chips only), neither coherent integration nor non-coherent integration performs desirably to find the peak of the CAF for the prime code signal. Various embodiments of the present disclosure provide an exemplary SCI framework as illustrated in FIG. 9. FIG. 9 depicts an exemplary schematic of SCI according to various disclosed embodiments of the present disclosure. In one embodiment, the SCI may be implemented in hardware such as PC, universal software radio peripheral (USRP), field-programmable gate array (FPGA) and/or the like. In the SCI framework, the sub-integration length may be established to be the half of the navigation data's symbol duration, which may correspond to either 5 ms or 20 ms, thereby ensuring that there is, at most, one data value change within every two sub-integrations and facilitating more precise signal processing and acquisition. Referring to FIG. 9, the prime code signal may include a plurality of sub-integration pairs, and each sub-integration pair may include the first sub-integration and the second sub-integration.

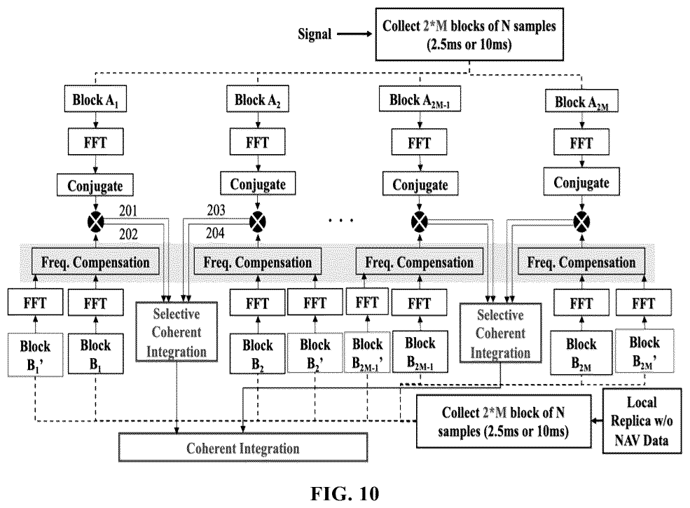

The SCI may execute a parallel search using Fast Fourier Transform (FFT) and Inverse Fast Fourier Transform (IFFT). This acceleration may leverage the resemblance between convolution and cross-correlation. Recognizing that convolution in the time domain is equivalent to multiplication in the frequency domain, a computationally efficient method may be configured to compute the convolution of two signals. The computational efficient method is described as the following. In one embodiment, referring to FIGS. 9-10, complex FFT of both signals may be computed; multiplication of complex FFT_1 (e.g., the first signal) and conjugate complex FFT_2 (e.g., the second signal) may be performed; and inverse FFT of multiplication may be performed. By exploiting such relationship, the processing of signals may be streamlined, thereby enhancing computational efficiency while maintaining accuracy.

Referring to FIG. 9, two local replicas including the first replica and the second replica may be generated. The first replica may represent the prime code signal without data. However, the second replica may incorporate negative data values on all odd chips (i.e., illustrated in FIG. 9 as oval shapes with pattern filling), that is, all odd chips (bits or digits) may be multiplied with negative value-1, as shown in FIG. 9. Such specialized design may be instrumental in facilitating SCI to effectively handle the data bits present in the prime code signals. By generating above-mentioned replicas with specific modifications, the SCI may optimize ability to accurately process and acquire the prime code signals, thereby improving overall performance and robustness.

As depicted in FIG. 9, the FFT/IFFT based convolution of received signal and local replicas may be executed. For each sub-integration (or subframe), the process may yield two convolution results. Two convolution results of the first sub-integration may be compared, that is, the maximum peak values of two convolution results of the first sub-integration may be compared; and bigger maximum peak value in the maximum peak values of two convolution results of the first sub-integration may be selected as the first convolution peak value. Above-mentioned comparison may be repeated for the second sub-integration. Two convolution results of the second sub-integration may be compared, that is, the maximum peak values of two convolution results of the second sub-integration may be compared; and bigger maximum peak value in the maximum peak values of two convolution results of the second sub-integration may be selected as the second convolution peak value. Subsequently, the first convolution peak value and the second convolution peak value may be compared, and bigger convolution peak value of the first convolution peak value and the second convolution peak value may be selected. If smaller convolution peak value of the first convolution peak value and the second convolution peak value exceeds a predefined threshold (indicating significance), smaller convolution peak value of the first convolution peak value and the second convolution peak value may be also selected (i.e., considered). Final step of the SCI may involve summing (IFFT) convolution results corresponding to selected peak values, thereby consolidating acquired signal information for further processing. That is, final step may be to sum up the inverse FFT (IFFT) of the selected FFT results. It should be noted that the FFT results are in frequency domain; the IFFT results are in time domain; and the summation is performed in the time domain.

FIG. 10 depicts an exemplary block diagram of (SCI) based parallel and direct acquisition for prime code signals according to various disclosed embodiments of the present disclosure. The overall exemplary block diagram of the direct prime code acquisition is depicted in FIG. 10, where N represents the number of samples during half of the data symbol duration (5 ms or 20 ms). The prime code signal may include the plurality of sub-integration pairs (i.e., a number M of sub-integration pairs), and each sub-integration pair may include the first sub-integration and the second sub-integration. The blocks including the block A1, . . . , and the block A2M may correspond to corresponding segments of the prime code signal. The blocks including the block B1, . . . , and the block B2M may correspond to the first local replicas. The blocks including the block B1′, . . . , and the block B2M′ may correspond to the second local replicas, where odd chips may carrier feature negative data values. For example, the block A1, the block B1 and the block B1′ may respectively correspond the prime code signal, the first local replica and the second local replica at the first sub-integration of the first sub-integration pair; and the block A2, the block B2 and the block B2′ may respectively correspond the prime code signal, the first local replica and the second local replica at the second sub-integration of the first sub-integration pair. For another example, the block A2M-1, the block B2M-1 and the block B2M-1′ may respectively correspond the prime code signal, the first local replica and the second local replica at the first sub-integration of the M-th sub-integration pair; and the block A2M, the block B2M and the block B2M′ may respectively correspond the prime code signal, the first local replica and the second local replica at the second sub-integration of the M-th sub-integration pair. Frequency compensation (i.e., freq. compensation shown in FIG. 10) may be conducted after FFT leveraging the circular frequency shift property inherent in FFT operations. Referring to FIGS. 9-10, at exemplary step 201, one FFT convolution result of the prime code signal and the first local replica at the first sub-integration of the first sub-integration pair may be inputted into SCI; and at exemplary step 202, another FFT convolution result of the prime code signal and the second local replica at the first sub-integration of the first sub-integration pair may be inputted into SCI. Still referring to FIGS. 9-10, at exemplary step 203, one FFT convolution result of the prime code signal and the first local replica at the second sub-integration of the first sub-integration pair may be inputted into SCI; and at exemplary step 204, another FFT convolution result of the prime code signal and the second local replica at the second sub-integration of the first sub-integration pair may be inputted into SCI. Subsequently, the coherent integration of the SCI results may entail summing all results together, thereby consolidating the information obtained from the parallel search process.

In the SCI framework, the second search may be tailored for the prime code Doppler adjustments. The initial search, involving extensive ITU (initial time uncertainty) and IFU (initial time uncertainty), may need time to be approximately 10 seconds. Considering a Doppler shift of 16 Hz for the binary offset carrier (BOC) (10,5) code, a potential offset of up to 160 chips during initial search phase may be expected. Therefore, a refined search with reduced ITU of +160 chips may be conducted subsequently. If the second search can be completed within 1/16 of a second, equivalent to 62.5 milliseconds, no additional chip offset may occur, and tracking may be proceeded. According to various embodiments of the present disclosure, the search may take around 50 milliseconds.

According to embodiments of the present disclosure, various signal-to-noise ratio (SNR) levels may be configured to evaluate the efficacy of the acquisition method (e.g., algorithm). The thermal noise of an antenna and receiver hardware may be configured to specify noise density and calculated as follows:

$${N}_{o} ( \frac{dBW}{H z} ) = 10 log 10 K T ,$$

where K denotes Boltzmann's constant (1.38×10-23 Joule per K), and T denotes Kelvin temperature (290 K).

The carrier power C of a GPS reference code receiver may be around −158 dBW (for L1) and −161 dBW (for L2). The carrier to noise density ratio (C/No) may be calculated as follows:

$$\frac{C}{{N}_{0}} = - 158 - 10 log 10 ( 1.38 \times 1 {0}^{- 23} \times 290 ) = 46 dB - Hz$$

The sampling frequency may be configured as around 40.92 MHZ, such that

$$SNR ( dB ) = \frac{c}{{N}_{0}} - 10 log 10 ( fs ) = 46 - 76 = - 30 dB .$$

The −30 dB may be the operational SNR for the M receiver. To test the anti-jam performance, the SNR range may be set as [−55 dB, −26 dB]. SNR=−55 dB may have 25 dB anti-jam gain.

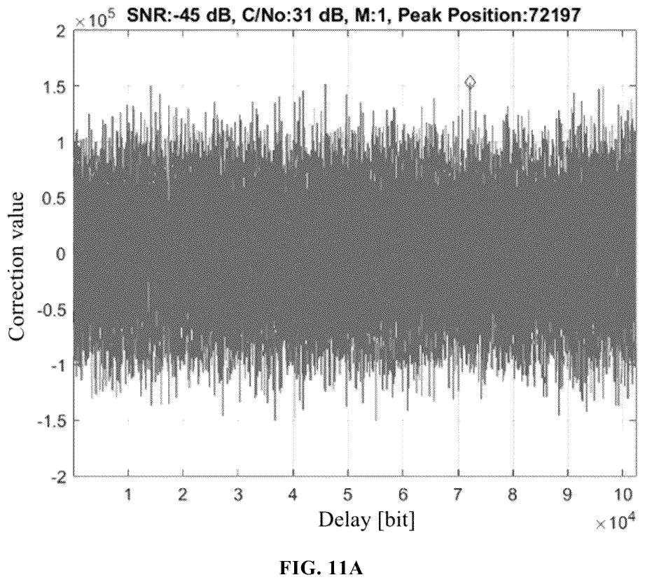

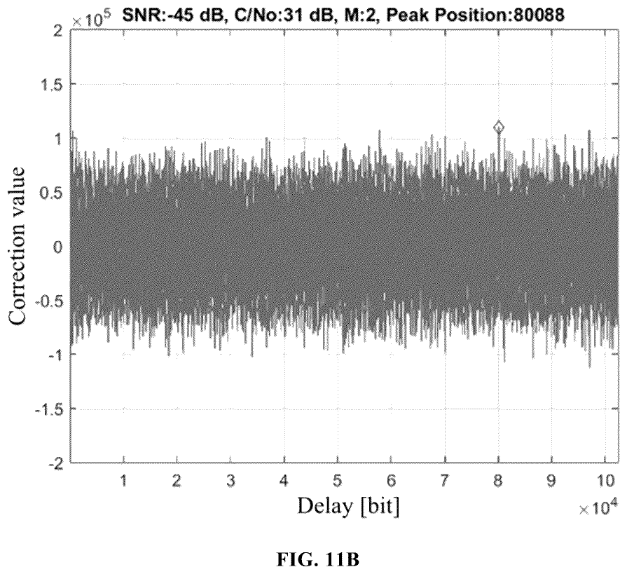

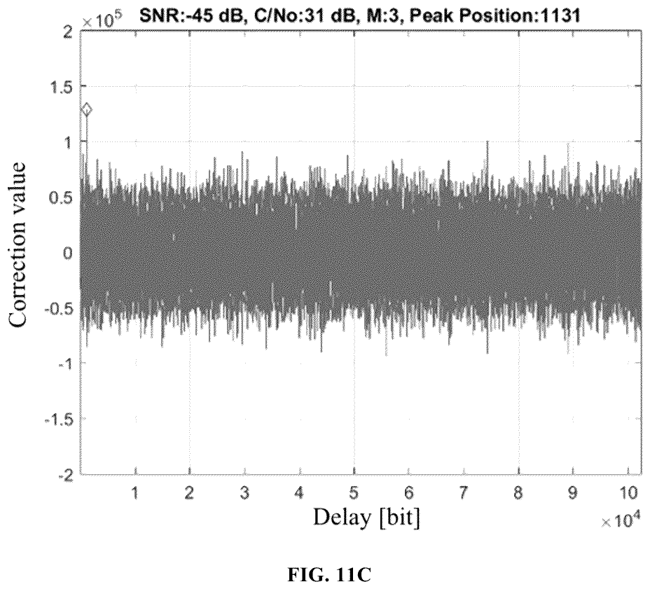

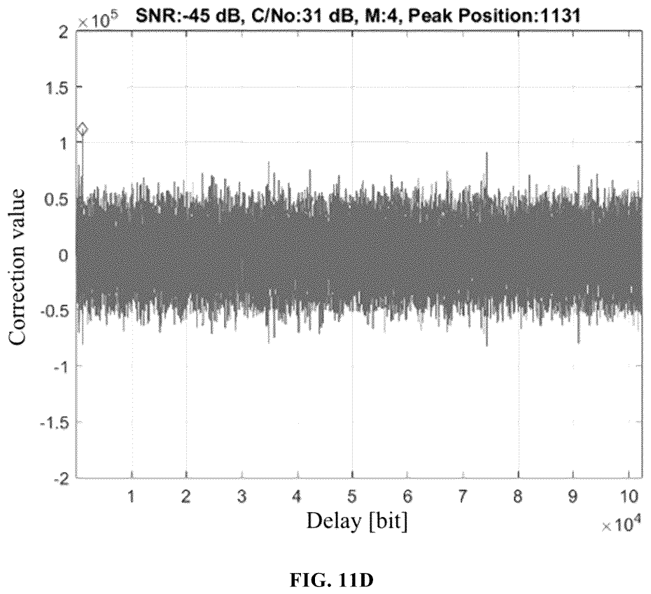

The SCI results for SNR=−45 dB are illustrated in FIGS. 11A-11D. FIG. 11A depicts an exemplary schematic of average correlation from selective coherent integration (SCI) for prime code signal acquisition for M=1 according to various disclosed embodiments of the present disclosure; FIG. 11B depicts an exemplary schematic of average correlation from selective coherent integration (SCI) for prime code signal acquisition for M=2 according to various disclosed embodiments of the present disclosure; FIG. 11C depicts an exemplary schematic of average correlation from selective coherent integration (SCI) for prime code signal acquisition for M=3 according to various disclosed embodiments of the present disclosure; and FIG. 11D depicts an exemplary schematic of average correlation from selective coherent integration (SCI) for prime code signal acquisition for M=4 according to various disclosed embodiments of the present disclosure. The ground truth peak location may be identified as 1131. According to embodiments of the present disclosure, M denotes a number of sub-integration pairs. When only two sub-integrations (M=1, that is, one sub-integration pair) or four sub-integrations (M=2, that is, two sub-integration pairs) are used, the peak and peak location may be incorrect due to weak received signal. However, the SCI based on two additional sub-integrations (M=3, six sub-integrations, that is, three sub-integration pairs) may yield accurate results. Furthermore, when eight sub-integrations (M=4, that is, four sub-integration pairs) are used, the peak may become clearer compared to six sub-integrations (M=3). Above-mentioned findings may demonstrate that the SCI may effectively accumulate the signal correlation values, thereby enhancing acquisition performance of the prime code signal.

According to various embodiments of the present disclosure, detection probability (P_{d})

$$acquisition margins ( {f}_{m} = \frac{Largest correlation result}{Second largest correlation result} , and {f}_{a} = \frac{Largest correlation result}{Average of correlation results} )$$

and may be used as primary acquisition metrics for evaluation.

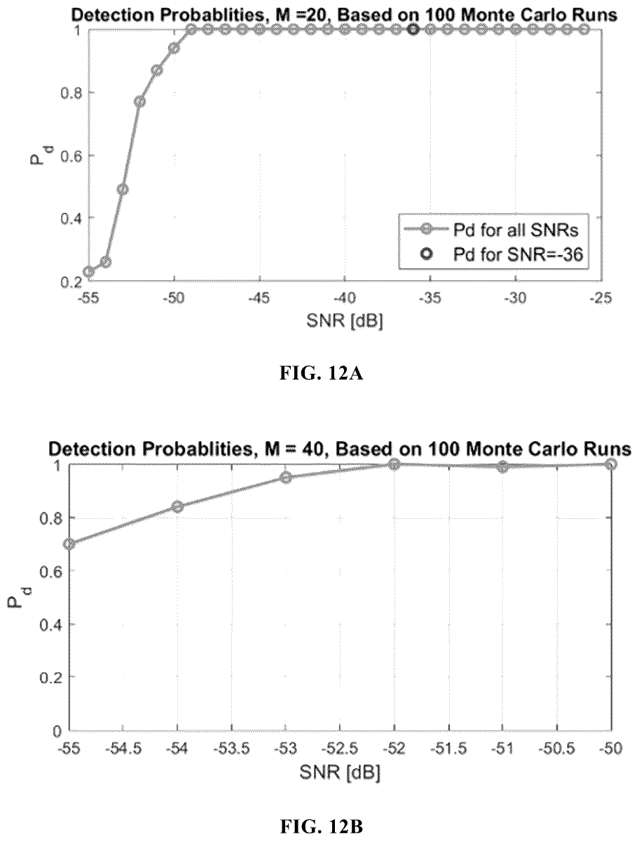

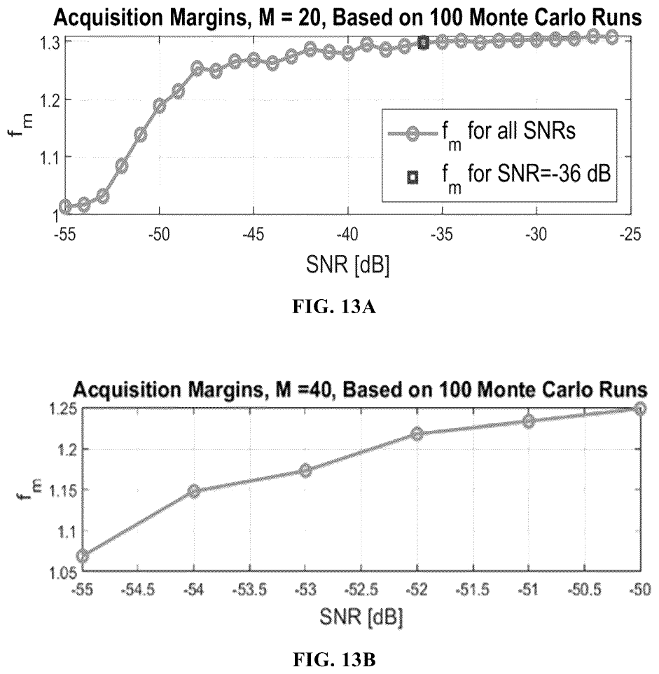

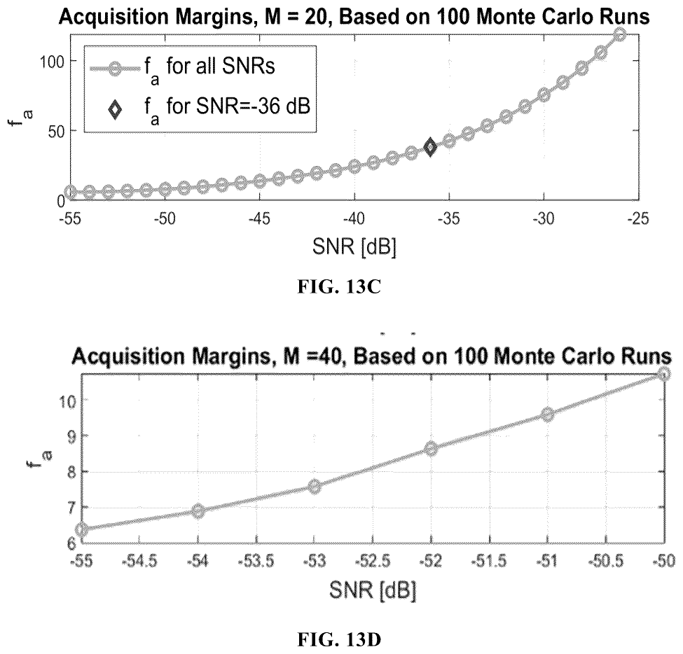

100 Monte Carlo runs may be conducted for each SNR level to calculate corresponding statistics. FIG. 12A depicts an exemplary schematic of detection probabilities for M=20 according to various disclosed embodiments of the present disclosure; and FIG. 12B depicts an exemplary schematic of detection probabilities for M=40 according to various disclosed embodiments of the present disclosure. For M=20, the acquisition performance may remain desirable until SNR=−49 dB. An acceptable detection probability of 0.8 may be achieved at SNR=−52 dB, however, SNRs below-53 dB may yield poor acquisition results. Therefore, the M value may be increased to 40, where desirable detection probabilities for low SNRs may be observed. Even at SNR=−52 dB, desirable results with the detection probability of 100% may be achieved. Overall, the direct acquisition method may exhibit performance gain of around 22 dB. FIG. 13A depicts an exemplary schematic of acquisition margins for M=20 according to various disclosed embodiments of the present disclosure; FIG. 13B depicts an exemplary schematic of acquisition margins for M=40 according to various disclosed embodiments of the present disclosure; FIG. 13C depicts an exemplary schematic of acquisition margins for M=20 according to various disclosed embodiments of the present disclosure; and FIG. 13D depicts an exemplary schematic of acquisition margins for M=40 according to various disclosed embodiments of the present disclosure. The acquisition margins, shown in FIGS. 13A-13D, may complement above-mentioned findings. Referring to FIGS. 13A-13D, FIG. 13A illustrates fₘ may change along different SNR values when M=20; FIG. 13B illustrates fₘ may change along low SNR ranges when M=40 (M may be increased to obtain desirable results for low SNRs); FIG. 13C illustrates fa may change along different SNR values when M=20; and FIG. 13D illustrates fa changes along low SNR ranges when M=40 (M may be increased to obtain desirable results for low SNRs).

For GNSS (global navigation satellite systems) receivers, various forms of radio frequency interference (RFI) signals may pose potential challenges, including continuous waves (CW), multi-tone signals, swept CW (chirp), and matched spectral jamming. Among above-mentioned challenges, matched spectral jamming may stand out as particularly detrimental for the prime code acquisition. Such type of interference may involve generating a waveform with a structure similar to the waveform of authentic signal, which may make the interference highly destructive. Matched spectral jamming may have the capacity to evade the target receiver's correlator and significantly impair correlation operations. Therefore, in the present disclosure, the worst-case scenario of matched spectral jamming may be performed by employing an approach that involves recording and rebroadcasting the prime signals from different time periods, which may allow accurately replicate the effects of jamming interference, thereby facilitating comprehensive evaluation and analysis.

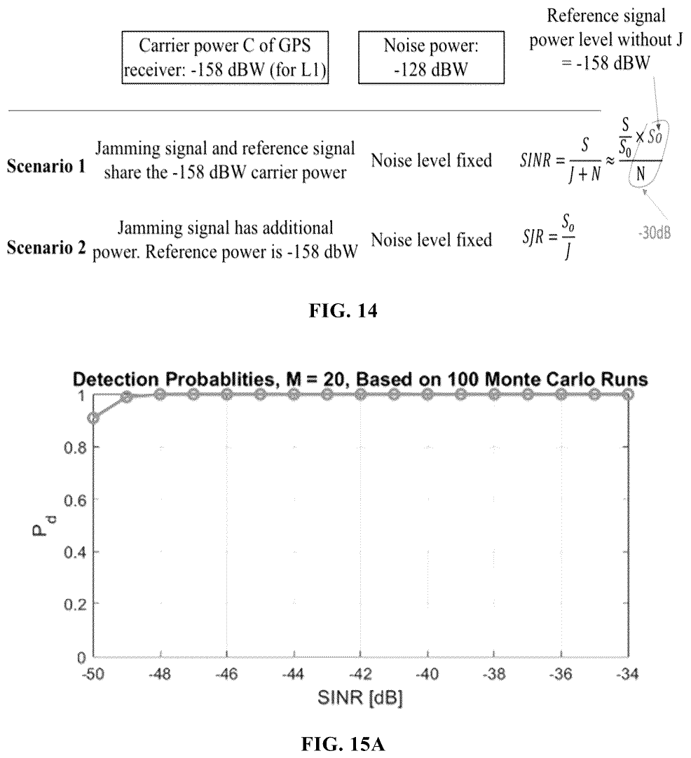

Two scenarios for the matched spectral jamming are illustrated in FIG. 14. FIG. 14 depicts an exemplary schematic of two scenarios for setting jamming powers according to various disclosed embodiments of the present disclosure. Matched spectrum jamming (FJS) is a type of jamming that generates a signal that closely matches the spectrum of the data signal.

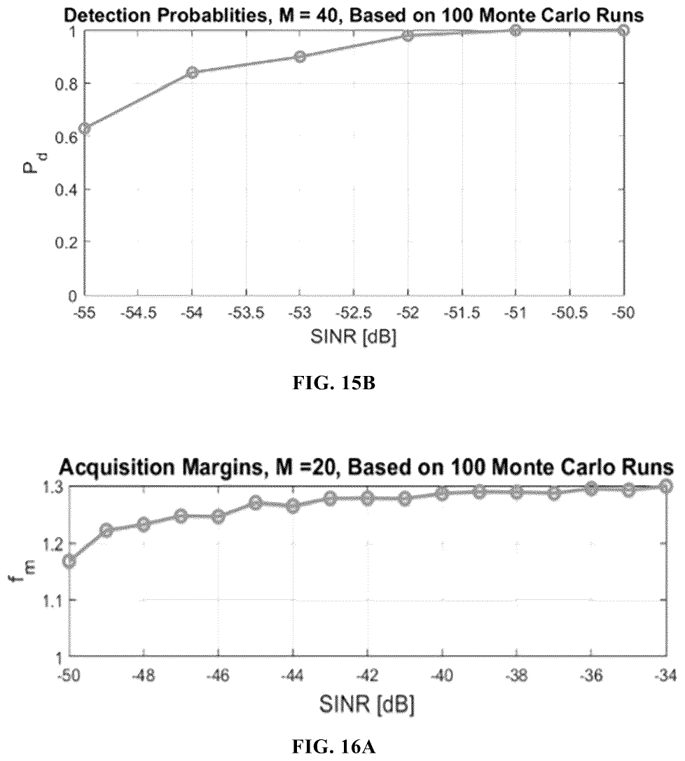

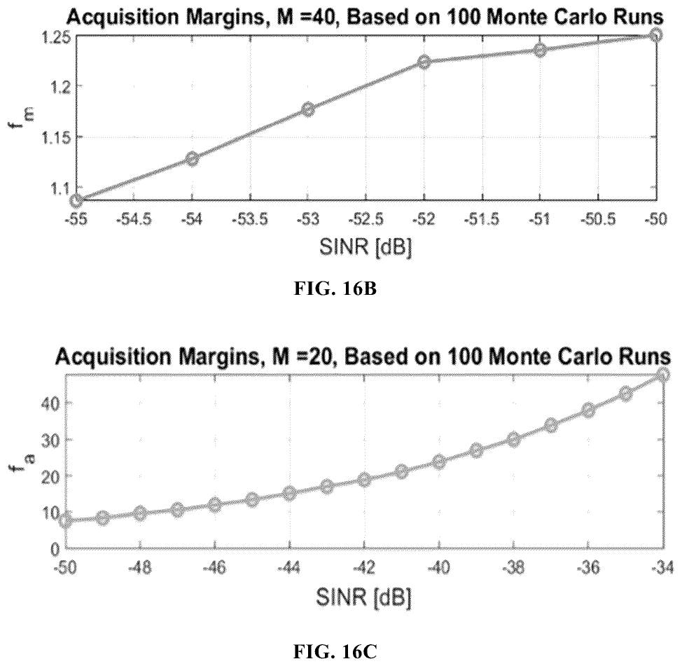

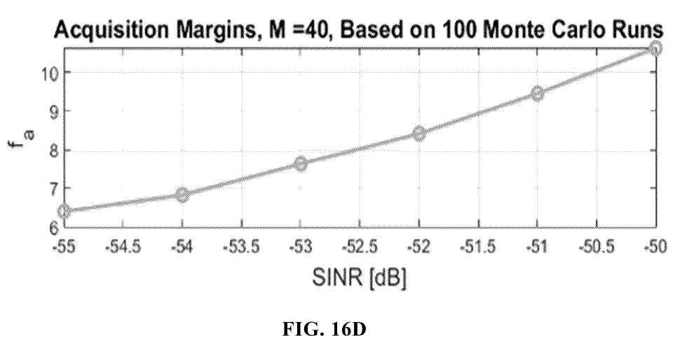

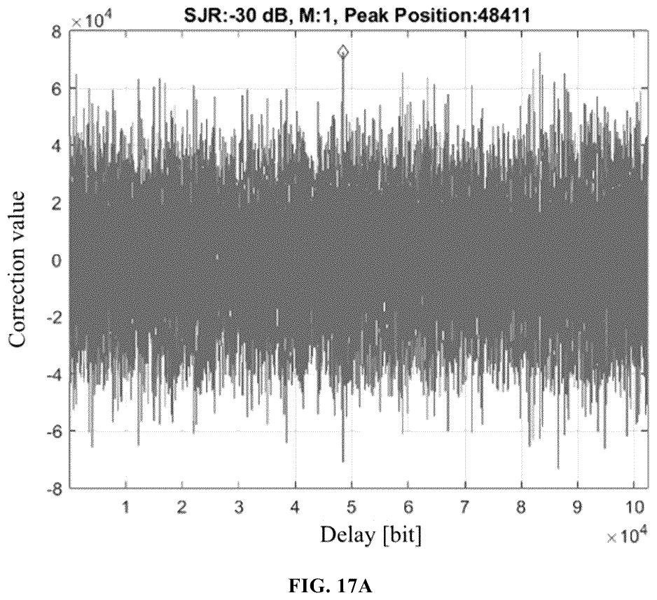

FIG. 15A depicts an exemplary schematic of detection probabilities for M=20 at scenario 1 according to various disclosed embodiments of the present disclosure; and FIG. 15B depicts an exemplary schematic of detection probabilities for M=40 at scenario 1 according to various disclosed embodiments of the present disclosure. FIG. 16A depicts an exemplary schematic of acquisition margins for M=20 at scenario 1 according to various disclosed embodiments of the present disclosure; FIG. 16B depicts an exemplary schematic of acquisition margins for M=40 at scenario 1 according to various disclosed embodiments of the present disclosure; FIG. 16C depicts an exemplary schematic of acquisition margins for M=20 at scenario 1 according to various disclosed embodiments of the present disclosure; and FIG. 16D depicts an exemplary schematic of acquisition margins for M=40 at scenario 1 according to various disclosed embodiments of the present disclosure. The performance of the acquisition method are shown in FIGS. 15A-15B and 16A-16D. As shown in FIG. 14, for the scenario 1, the signal power and jamming power may be set according to the SINR. The prime code signal power may be first calculated, and remaining power may be assigned to the jamming signals. Similar results for the SNR cases (as shown in FIGS. 12A-12B and 13A-13D) may be obtained, where only white Gaussian noises are added to the prime code signals.

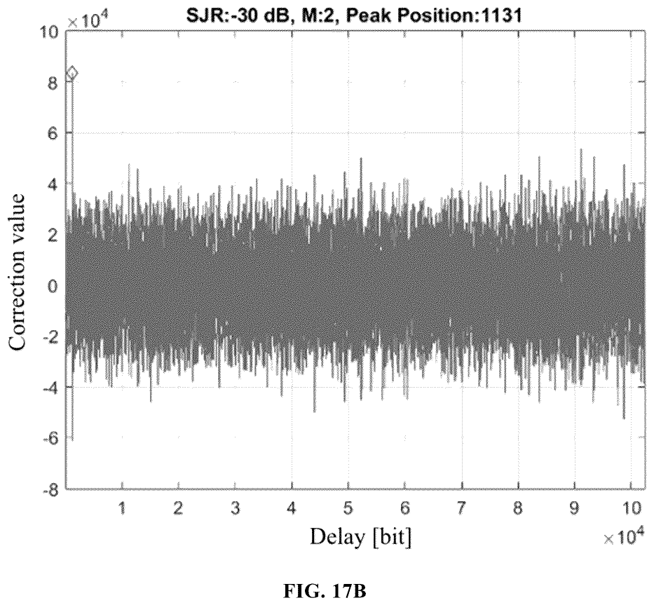

For scenario 2, the signal-to-jamming ratio (SJR) may be evaluated at −30 dB. FIG. 17A depicts an exemplary schematic of average correlation from selective coherent integration (SCI) for prime code signal acquisition for M=1 according to various disclosed embodiments of the present disclosure; and FIG. 17B depicts an exemplary schematic of average correlation from selective coherent integration (SCI) for prime code signal acquisition for M=2 according to various disclosed embodiments of the present disclosure. It should be noted that, even when M equals 2, the peak may be already distinctly clear, as depicted in FIGS. 17A-17B.

When SJR=−30 dB, the equivalent (signal-to-interference-plus-noise ratio)

$$SINR = \frac{{S}_{0}}{N + J} = 0.5 \times \frac{{S}_{o}}{N} = - 33 dB$$

because the

$$\frac{{S}_{o}}{N} = - 30 dB$$

as analyzed before with s₀=−158 dBW, where J may be the jamming signal power level, N may be the noise power level, and S₀ may be the reference signal power level without jamming power. J may be equal to N, such that

$$\frac{{S}_{0}}{N + J} = 0.5 \times \frac{{S}_{o}}{N} .$$

Similarly, if SJR=−50 dB, the SINR may be also −50 dB. For scenario 2 (signal power and noise power are fixed), similar results as scenario 1 may be obtained when the SINR is configured to enumerate the jamming power.

Various embodiments of the present disclosure provide a system. The system includes a memory, configured to store program instructions for performing a signal acquisition method based on selective coherent integration (SCI) for anti-jam of protected global positioning system (GPS) user equipment; and a processor, coupled with the memory and, when executing the program instructions, configured for: establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal, where the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results; comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

Various embodiments of the present disclosure provide a non-transitory computer-readable storage medium, containing program instructions for, when being executed by a processor, performing signal acquisition method based on selective coherent integration (SCI) for anti-jam of protected global positioning system (GPS) user equipment. The method includes establishing a sub-integration length of a prime code signal to be a half of a symbol duration of navigation data, where the prime code signal is received by a signal receiver and includes a plurality of sub-integration pairs, and each sub-integration pair includes a first sub-integration and a second sub-integration; for each sub-integration, generating a first local replica and a second local replica based on the prime code signal, where the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results; comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

From above-mentioned embodiments, it may be seen that at least following beneficial effects may be achieved in the present disclosure.

The effectiveness of selective coherent integration-based optimal acquisition method for MGUE in bolstering anti-jamming capabilities is demonstrated in the present disclosure. Through rigorous analysis and evaluation, the acquisition method (algorithm) has the ability to mitigate the impact of jamming interference.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is:

1. A signal acquisition method based on selective coherent integration (SCI) for anti-jam of protected global positioning system (GPS) user equipment, comprising:
establishing a sub-integration length of a prime code signal to be a half of a symbol duration of navigation data, wherein the prime code signal is received by a signal receiver and includes a plurality of sub-integration pairs, and each sub-integration pair includes a first sub-integration and a second sub-integration;
for each sub-integration, generating a first local replica and a second local replica based on the prime code signal, wherein the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results;
comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and
comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

2. The method according to claim 1, after selecting the first convolution peak value if the first convolution peak value is greater than the second convolution peak value, further including:
if a ratio of the second convolution peak value over the first convolution peak value exceeds a predefined threshold, selecting the second convolution peak value.

3. The method according to claim 2, further including:
executing inverse fast Fourier transform (IFFT) based convolution on convolution results corresponding to the first convolution peak and the second convolution peak value to respectively obtain two IFFT convolution results; and summing the two IFFT convolution results to obtain summed IFFT convolution result to be outputted.

4. The method according to claim 1, after selecting the second convolution peak value if the first convolution peak value is less than the second convolution peak value, further including:
if a ratio of the first convolution peak value over the second convolution peak value exceeds a predefined threshold, selecting the first convolution peak value.

5. The method according to claim 4, further including:
executing inverse fast Fourier transform (IFFT) based convolution on convolution results corresponding to the first convolution peak and the second convolution peak value to respectively obtain two IFFT convolution results; and summing the two IFFT convolution results obtain summed IFFT convolution result to be outputted.

6. The method according to claim 1, wherein executing fast Fourier transform (FFT) based convolution on the prime code signal, the first local replica and the second local replica to yield two convolution results includes:
executing fast Fourier transform (FFT) based convolution on the prime code signal and the first local replica to yield one convolution result; and
executing fast Fourier transform (FFT) based convolution on the prime code signal and the second local replica to yield another second convolution result.

7. A system, comprising:
a memory, configured to store program instructions for performing a signal acquisition method based on selective coherent integration (SCI) for anti-jam of protected global positioning system (GPS) user equipment; and
a processor, coupled with the memory and, when executing the program instructions, configured for:
establishing a sub-integration length of a prime code signal to be a half of a symbol duration of navigation data, wherein the prime code signal is received by a signal receiver and includes a plurality of sub-integration pairs, and each sub-integration pair includes a first sub-integration and a second sub-integration;
for each sub-integration, generating a first local replica and a second local replica based on the prime code signal, wherein the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results;
comparing two convolution maximum peak values respectively corresponding to two convolution results of the first sub-integration and selecting a convolution maximum peak value with higher magnitude in the first sub-integration as a first convolution peak value; and comparing two convolution maximum peak values respectively corresponding to two convolution results of the second sub-integration and selecting a convolution maximum peak value with higher magnitude in the second sub-integration as a second convolution peak value; and
comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

8. The system according to claim 7, wherein after selecting the first convolution peak value if the first convolution peak value is greater than the second convolution peak value, the processor is further configured to:
if a ratio of the second convolution peak value over the first convolution peak value exceeds a predefined threshold, select the second convolution peak value.

9. The system according to claim 8, wherein the processor is further configured to:
execute inverse fast Fourier transform (IFFT) based convolution on convolution results corresponding to the first convolution peak and the second convolution peak value to respectively obtain two IFFT convolution results; and sum the two IFFT convolution results to obtain summed IFFT convolution result to be outputted.

10. The system according to claim 7, wherein after selecting the second convolution peak value if the first convolution peak value is less than the second convolution peak value, the processor is further configured to:
if a ratio of the first convolution peak value over the second convolution peak value exceeds a predefined threshold, select the first convolution peak value.

11. The system according to claim 10, wherein the processor is further configured to:
executing inverse fast Fourier transform (IFFT) based convolution on convolution results corresponding to the first convolution peak and the second convolution peak value to respectively obtain two IFFT convolution results; and summing the two IFFT convolution results obtain summed IFFT convolution result to be outputted.

12. The system according to claim 7, wherein for executing fast Fourier transform (FFT) based convolution on the prime code signal, the first local replica and the second local replica to yield two convolution results, the processor is further configured to:
execute fast Fourier transform (FFT) based convolution on the prime code signal and the first local replica to yield one convolution result; and
execute fast Fourier transform (FFT) based convolution on the prime code signal and the second local replica to yield another second convolution result.

13. A non-transitory computer-readable storage medium, containing program instructions for, when being executed by a processor, performing a signal acquisition method based on selective coherent integration (SCI) for anti-jam of protected global positioning system (GPS) user equipment; the method comprising:
establishing a sub-integration length of a prime code signal to be a half of a symbol duration of navigation data, wherein the prime code signal is received by a signal receiver and includes a plurality of sub-integration pairs, and each sub-integration pair includes a first sub-integration and a second sub-integration;
for each sub-integration, generating a first local replica and a second local replica based on the prime code signal, wherein the first local replica does not include navigation data, and the second local replica includes navigation data which incorporates negative data values on all corresponding odd chips; and executing fast Fourier transform (FFT) based convolution on the prime code signal, the first local replica and the second local replica to yield two convolution results;
comparing two convolution maximum peak values respectively corresponding to two convolution results of the first sub-integration and selecting a convolution maximum peak value with higher magnitude in the first sub-integration as a first convolution peak value; and
comparing two convolution maximum peak values respectively corresponding to two convolution results of the second sub-integration and selecting a convolution maximum peak value with higher magnitude in the second sub-integration as a second convolution peak value; and
comparing the first convolution peak value and the second convolution peak value; selecting the first convolution peak value if the first convolution peak value is greater than or equal to the second convolution peak value, and executing inverse fast Fourier transform (IFFT) based convolution on a convolution result corresponding to the first convolution peak to obtain an IFFT convolution result to be outputted; and selecting the second convolution peak value if the first convolution peak value is less than the second convolution peak value, and executing inverse fast Fourier transform (IFFT) based convolution on a convolution result corresponding to the second convolution peak to obtain an IFFT convolution result to be outputted.

14. The storage medium according to claim 13, wherein after selecting the first convolution peak value if the first convolution peak value is greater than the second convolution peak value, the processor is further configured to:
if a ratio of the second convolution peak value over the first convolution peak value exceeds a predefined threshold, select the second convolution peak value.

15. The storage medium according to claim 14, wherein the processor is further configured to:
execute inverse fast Fourier transform (IFFT) based convolution on convolution results corresponding to the first convolution peak and the second convolution peak value to respectively obtain two IFFT convolution results; and sum the two IFFT convolution results to obtain summed IFFT convolution result to be outputted.

16. The storage medium according to claim 13, wherein after selecting the second convolution peak value if the first convolution peak value is less than the second convolution peak value, the processor is further configured to:
if a ratio of the first convolution peak value over the second convolution peak value exceeds a predefined threshold, select the first convolution peak value.

17. The storage medium according to claim 16, wherein the processor is further configured to:
executing inverse fast Fourier transform (IFFT) based convolution on convolution results corresponding to the first convolution peak and the second convolution peak value to respectively obtain two IFFT convolution results; and summing the two IFFT convolution results obtain summed IFFT convolution result to be outputted.

18. The storage medium according to claim 13, wherein for executing fast Fourier transform (FFT) based convolution on the prime code signal, the first local replica and the second local replica to yield two convolution results, the processor is further configured to:
execute fast Fourier transform (FFT) based convolution on the prime code signal and the first local replica to yield one convolution result; and
execute fast Fourier transform (FFT) based convolution on the prime code signal and the second local replica to yield another second convolution result.
